(19) United States
(12) Patent Application Publication
(10) Pub. No.: US 2014/0220523 A1
(43) Pub. Date: Aug. 7, 2014

(54) METHODS OF ANALYZING AN INDIVIDUAL'S PERSONALITY

(71) Applicant: ALPHA ELEMENT INSTITUTE, LLC, Excelsior, MN (US)

(72) Inventor: Marit Solheim Witt, Excelsior, MN (US)

(73) Assignee: ALPHA ELEMENT INSTITUTE, LLC, Excelsior, MN (US)

(21) Appl. No.: 13/760,715

(22) Filed: Feb. 6, 2013

(51) Int. Cl. G09B 19/00

(52) U.S. Cl. CPC G09B 19/00
USPC 434/236

(57) ABSTRACT

Methods of analyzing the personality of an individual are disclosed and include at least one of assessing the relationship of the individual's face to four shapes, determining which one of four shades of red harmonizes best with the individual's face, determining which set of colored patterns harmonizes best with the individual's face, determining which metal palette harmonizes best with the individual's face, determining which red shape harmonizes best with the individual's face, and determining which color palette harmonizes best with the individual's face, and correlating at least one of the selected shape, shade of red, set of colored patterns, metal palette, red shape, and color palette with a mind-body temperament, and identifying the primary mind-body temperament of the individual.

### BACKGROUND

The invention relates to analyzing and determining aspects of the personality of an individual.

Many employers use personality assessments to help determine whether or not an employee is well suited to a particular position, to understand the personality of an employee, and to learn how to interact most effectively with an employee. Personality assessments are also used by psychologists to aid in diagnosis of a patient and to guide the patient to behaviors and thought processes that will better enable the patient to exist and interact in society on a day to day basis. Many individuals also seek to better understand their personalities, learning styles, and communication styles to improve job performance and effective interaction with coworkers, friends, and family members.

Many of the current systems for analyzing an individual's personality assess an individual's perception and experience of the world and the manner in which the individual makes decisions. However, existing systems do not assess and identify the various energy elements that make up an individual's personality.

There is a need for a personality assessment tool that is able to analyze and identify the characteristics of the energy elements and the body elements of an individual's personality.

### SUMMARY

In one aspect, the invention features a method of analyzing the personality of an individual, the method includes 1) assessing the relationship of the individual's face to four shapes, the four shapes including circle, an oval, a triangle, and rectangular, determining which one of the four shapes harmonizes the best with the individual's face, selecting the shape that harmonizes best with the individual's face, and correlating the selected shape with one of four mind-body temperaments, 2) determining which one of four shades of red harmonizes best with the individual's face, selecting the shade of red that that harmonizes best with the individual's face, correlating the shade of red with one of four mind-body temperaments, 3) determining which set of colored patterns selected from a group of four sets of colored patterns harmonizes best with the individual's face, selecting the set of colored patterns that harmonizes best with the individual's face, correlating the selected set of color patterns to one of four mind-body temperaments, 4) determining which metal palette selected from a group consisting of four metal palettes harmonizes best with the individual's face, selecting the metal palette that harmonizes best with the individual's face, correlating the selected metal palette to one of four mind-body temperaments, 5) determining which red shape selected from a group of at least four red shapes harmonizes best with the individual's face, selecting the red shape that harmonizes best with the individual's face, and correlating the selected red shape with one of four mind-body temperaments, 6) determining which color palette selected from a group consisting of at least four color palettes harmonizes best with the individual's face, selecting the color palette that harmonizes best with the individual's face, and correlating the selected color palette with one of four mind-body temperaments, and 7) identifying the mind-body temperament correlated to the selected color palette as the primary mind-body temperament of the individual.

In another aspect, the invention features a method of analyzing the personality of an individual, the method includes obtaining a first set of data pertaining to a first professional style of the individual, obtaining a second set of data pertaining to a second personal style of the individual, correlating the first set of data with at least one mind-body temperament selected from a group consisting of at least four different mind-body temperaments, correlating the second set of data with at least one mind-body temperament selected from the group of at least four different mind-body temperaments, and analyzing the correlation between the at least one mind-body temperament associated with the first set of data and with the at least one mind-body temperament associated with the second set of data. In one embodiment, the first set of data includes responses to a first questionnaire and the second set of data includes responses to a second questionnaire. In another embodiment, the method further includes determining the degree to which the first set of data corresponds to each of the four mind-body temperaments, and determining the degree to which the second set of data corresponds to each of the four mind-body temperaments.

In some embodiments, the method further includes determining the perceived primary mind-body temperament of the individual, the determining including determining to which mind-body temperament the first set of data exhibits the greatest degree of correlation and assigning the determined mind-body temperament as the first perceived personality style, and determining to which mind-body temperament the second set of data exhibits the greatest degree of correlation and assigning the determined mind-body temperament as the second perceived personality style.

In another aspect, the invention features a method of analyzing the discontinuity in an individual's perceived personality style relative to the individual's assessed primary mind-body temperament, the method including comparing the perceived first and second personality styles of the individual with the primary mind-body temperament of the individual, determining whether there is a balance or an imbalance in the comparison, and informing the individual of the balance or imbalance.

In some embodiments the method further includes calculating the stress factor of the individual.

In other aspects, the invention features a method of analyzing the personality of an individual where the method includes assessing the relationship of the individual's face to a group of at least four shapes, the four shapes including a circular shape, an oval shape, triangular shape, and a rectangular shape, determining which one of the four shapes harmonizes best with the individual's face, selecting the shape that harmonizes best with the individual's face, and identifying the mind-body temperament correlated to the selected shape, the correlation of the mind-body temperament and the selected shape having been predetermined. In one embodiment, the method further includes ascribing the identified mind-body temperament to the individual as the individual's primary mind-body temperament. In another embodiment, the method further includes determining which one of the four shapes harmonizes the least with the individual's face. In some embodiments, the shape is in the form of a pair of sunglasses, the assessing includes placing the sunglasses on the face of the individual, and the determining includes determining which item of the group consisting of the individual's face and the sunglasses is seen first by an observer.

In one embodiment, the method of analyzing the personality of an individual includes determining which shade of red from a group of at least four shades of red harmonizes best with the individual's face, selecting the shade of red that that harmonize best with the individual's face, and identifying the mind-body temperament correlated to the selected shade of red, the correlation of the mind-body temperament to the selected shade of red having been predetermined.

In some embodiments, the method of analyzing the personality of an individual includes determining which set of colored patterns selected from a group of at least four sets of colored patterns harmonize best with the individual's face, selecting the set of colored patterns that harmonize best with the individual's face, and identifying the mind-body temperament correlated to the set of colored patterns, the correlation of the mind-body temperament and the selected set of colored patterns having been predetermined.

In other embodiments, the method of analyzing the personality of an individual includes determining which metal palette selected from a group of at least four metal palettes harmonizes best with the individual's face, each metal palette comprising a plurality of sections, each section including a metallic color and being different from each other section, selecting the metal palette that harmonizes best with the individual's face, and identifying the mind-body temperament correlated to the selected metal palette, the correlation of the mind-body temperament and the selected metal palette having been predetermined.

In another embodiment, the method of analyzing the personality of an individual includes determining which red shape selected from a group of at least two red shapes harmonizes best with the individual's face, each red shape including at least one of a circular shape, an oval shape, a triangular shape, and a rectangular shape, and having a different shape, selecting the selecting the red shape that harmonizes best with the individual's face, and identifying the mind-body temperament correlated to the selected red shape, the correlation of the mind-body temperament and the selected red shape having been predetermined.

On one embodiment, the method of analyzing the personality of an individual includes determining which color palette selected from a group of at least two color palettes harmonizes best with the individual's face, each color palette including a plurality of colored components, each colored component including a plurality of sections, each section including a color that is different from the color of each other section, selecting the color palette that harmonizes best with the individual's face, and identifying the mind-body temperament correlated to the selected color palette, the correlation of the mind-body temperament and the selected color palette having been predetermined. In some embodiments, the mind-body temperament correlated to the selected color palette is the primary mind-body temperament of the individual.

In other embodiments, the methods disclosed herein further include determining the second mind-body temperament of the individual. In some embodiments, the secondary mind-body temperament includes an emotional element of the personality of the individual.

In another embodiment, the methods disclosed herein further include determining the tertiary mind-body temperament of the individual. In one embodiment, the tertiary mind-body temperament corresponds to an intellectual element of the personality of the individual.

In other embodiments, the methods disclosed herein further include determining the quaternary mind-body temperament of the individual. In some embodiments, the quaternary mind-body temperament corresponds to the insight element of the personality of the individual.

In another aspect, the invention is directed to a method of determining the tertiary and quaternary mind-body temperaments of an individual, the method includes determining which two color palettes from a group of at least four color palettes harmonize the least with the individual's face, selecting the two color palettes that harmonize the least with the individual's face, determining which one color palette of the two selected least harmonizing color palettes harmonizes best with the individual's face, selecting the color palette that harmonizes the best with the individual's face from the two selected color palettes that harmonize the least with the individual's face, correlating the selected least harmonizing color palette that harmonizes the best with the individual's face to a tertiary mind-body temperament, the tertiary mind-body temperament being different from the primary and secondary mind-body temperaments, and correlating the least harmonizing color palette that harmonizes the least with the individual's face to a quaternary mind-body temperament, the quaternary mind-body temperament being different from the primary, secondary and tertiary mind-body temperaments. In one embodiment, the tertiary mind-body temperament corresponds to the intellectual element of the personality of the individual. In another embodiment, the quaternary mind-body temperament corresponds to the insight element of the personality of the individual.

In another aspect, the invention features a method of analyzing the personality of an individual, the method including determining which one of at least four shades of red harmonizes best with the individual's face, selecting the shade of red that that harmonizes best with the individual's face, identifying the mind-body temperament correlated to the selected red shade, the correlation of the mind-body temperament and the selected red shade having been predetermined, determining which set of colored patterns selected from a group of at least four sets of colored patterns harmonizes best with the individual's face, selecting the set of colored patterns that harmonizes best with the individual's face, identifying the mind-body temperament correlated to the selected colored pattern, the correlation of the mind-body temperament and the selected colored pattern having been predetermined, determining which metal palette selected from a group of at least four metal palettes harmonizes best with the individual's face, each metal palette including a plurality of sections, each section including a metallic color and being different from each other section, selecting the metal palette that harmonizes best with the individual's face, identifying the mind-body temperament correlated to the selected metal palette, the correlation of the mind-body temperament and the selected metal palette having been predetermined, determining which red shape selected from a group consisting of at least red shapes harmonizes best with the individual's face, selecting the red shape that harmonizes best with the individual's face, and identifying the mind-body temperament correlated to the selected red shape, the correlation of the mind-body temperament and the selected red shape having been predetermined, determining which first color palette selected from a group of at least two color palettes harmonizes best with the individual's face, each color palette including a plurality of colored components, each colored component including a plurality of sections, each section including color and each section being different from each other section, selecting the color palette that harmonizes best with the individual's face, identifying the mind-body temperament correlated to the first selected color palette, the correlation of the mind-body temperament and the first selected color palette having been predetermined, and identifying the mind-body temperament correlated to the first selected color palette as the primary mind-body temperament of the individual. In one embodiment, the group of at least two color palettes includes at least four color palettes and the method further includes determining which second color palette from a group of three color palettes harmonizes the best with the individual's face, the group of three color palettes being the group of at least four color palettes minus the first color palette correlated to the first mind-body temperament of the individual, selecting the color palette that harmonizes best the individual's face, the selected color palette being the second selected color palette, identifying the mind-body temperament correlated to the second selected color palette, the correlation of the mind-body temperament and the second selected color palette having been predetermined, and identifying the mind-body temperament correlated to the second selected color palette as the secondary mind-body temperament of the individual. In another embodiment, the method further includes removing the first and second selected color palettes form the group of at least four color palettes, determining which two color palettes of the group of at least four color palettes harmonize least with the individual's face, selecting a color palette that harmonizes the best with the individual's face from the two least harmonizing color palettes, the selected color palette being the third selected color palette, identifying the mind-body temperament correlated to the third selected color palette, the correlation of the mind-body temperament and the third selected color palette having been predetermined, and identifying the mind-body temperament correlated to the third selected color palette as the tertiary mind-body temperament of the individual.

In some embodiments, the method further includes selecting a color palette that harmonizes the least with the individual's face, the selected color palette being the fourth color palette, identifying the mind-body temperament correlated to the fourth selected color palette, the correlation of the mind-body temperament and the fourth selected color palette having been predetermined, and identifying the mind-body temperament correlated to the fourth selected color palette as the quaternary mind-body temperament of the individual. In other embodiments, the secondary mind-body temperament corresponds to an emotional element of the individual's personality. In another embodiment, the tertiary mind-body temperament corresponds to an intellectual element of the individual's personality. In some embodiments, the quaternary mind-body temperament corresponds to an insightful element of the individual's personality.

In other embodiments, the method further includes assessing the relationship of the individual's face to at least four shapes, the four shapes including a circular shape, an oval shape, a triangular shape, and a rectangular shape, determining which one of the at least four shapes harmonizes the best with the individual's face, selecting the shape that harmonizes best with the individual's face, and identifying the mind-body temperament correlated to the selected shape, the correlation of the mind-body temperament and the selected shape having been predetermined. In one embodiment, assessing the relationship of the individual's face to the at least four shapes occurs prior to determining which one of at least four shades of red harmonizes best with the individual's face.

The invention features a method of identifying the mind-body temperaments of four elements of an individual's personality.

Other features and advantages will be apparent from the following description of the drawings, the preferred embodiments, and from the claims. In the figures, like numbers are used to represent like elements.

### BRIEF DESCRIPTION OF THE DRAWINGS

FIG. 1 is a flow chart illustrating one method for determining the assessed primary mind-body temperament.

FIG. 2 is a flow chart illustrating one method for determining the assessed secondary mind-body temperament.

FIG. 3 is a flow chart illustrating one method for determining the assessed tertiary and assessed quaternary mind-body temperaments.

FIG. 4 is a flow chart illustrating another method of determining the assessed primary mind-body temperament.

FIG. 5 is a flow chart illustrating additional aspects of the method of FIG. 3.

### DETAILED DESCRIPTION

Light is reflected, refracted, or absorbed by a substance. The manner in which colors and patterns resonate with a person's face and body creates a picture of the energetic pattern of light associated with that individual. The light that is refracted by an individual creates information about the external energy of the individual. The light that is absorbed by an individual provides information about the internal energy of the individual. The energy of the individual includes information processing and potential for action. An individual exhibits four energy elements: instinctive, emotional, cerebral, and insightful.

The present inventors have identified four different mind-body temperaments associated with the light energy of an individual, which the present inventors refer to as Catalyst, Torchbearer, Pathfinder, and Pragmatist. Catalyst refers to a mind-body temperament that is open-minded, seeks excitement and to discover, and asks, “What if?” Torchbearer refers to a mind-body temperament that is transformative, seeks solution and results, and asks, “What?” Pathfinder refers to a mind-body temperament that is analytical, seeks meaning, looks for method, and asks, “Why?” Pragmatist refers to a mind-body temperament that is scrutinizing, seeks balance and structure, and asks, “How?”

Each mind-body temperament is associated with an energy element: the primary mind-body temperament, which is referred to herein as the Alpha-element, is the primary instinctive energy element of the individual's personality; the secondary mind-body temperament, which is referred to herein as the e-Beta element, is the emotional energy element of the individual's personality; the tertiary mind-body temperament, which is referred to herein as the i-Beta element, is the cerebral energy element of the individual's personality; the quaternary mind-body temperament, which is referred to herein as the Omega element, is the insight energy element (i.e., insightful energy element) of the individual's personality. The primary, secondary, tertiary, and quaternary mind-body temperaments can be further correlated to the classical elements (i.e., air, fire, water and earth, respectively) and the states of matter (i.e., gas, fire, liquid, and solid, respectively).

The method of analyzing the personality of an individual identifies the order of the individual's mind-body temperaments.

One step in the method of analyzing the personality of an individual includes determining two perceived personality styles of the individual: a perceived professional style and a perceived personal style. The first perceived personality style of an individual is determined by obtaining a first set of data pertaining to a professional style of the individual, obtaining a second set of data pertaining to a personal style of the individual, correlating the first set of data with at least one mind-body temperament selected from the group of four different mind-body temperaments, correlating the second set of data with at least one mind-body temperament selected from the group of four different mind-body temperaments, and analyzing the correlation between the at least one mind-body temperament associated with the first set of data and the at least one mind-body temperament associated with the second set of data.

The first set of data is obtained from the individual. The individual answers a first questionnaire. The questions on the first questionnaire are directed to the individual's perceptions about him or her -self in a professional environment. Each of the questions has four answers each identified by a unique identifier, e.g., A, B, C and D. The first questionnaire asks that the questions be answered by the individual based on the individual's perception of their professional personality. The questions are directed to a variety of categories including, e.g., how coworkers would describe the individual, what the individual's professional strengths are, for what the individual is typically recognized, what the individual likes best about his or herself from a professional perspective, what the individual struggles with, what the individual's primary nature is, the individual's then current overall self-perception, what the individual perceives as missing from his or her life, and how the individual responds to unexpected offers and problems.

Examples of useful question and answers for the first questionnaire include:
Most people at work would describe me as: A) up-beat B) outspoken C) low-key D) down-to-earth;
The element I usually bring to the table is best described as: A) lively B) bold C) philosophical D) to the point;
I tend to be recognized for contributing: A) ideas and excitement B) action and results C) process and planning D) clarity and quality;
What I like best about myself professionally is that I am: A) inquisitive B) passionate C) methodical D) realistic;
What I struggle with is that I can be: A) hasty B) restless C) slow D) introverted;
I can sometimes be too: A) inattentive B) careless C) meandering D) perfectionist;
I would say that I am primarily: A) innovative B) dynamic C) caring D) logical;
The letter with the statement that resonates MOST with you at this time is: A) I am spontaneous and playful B) I get things done C) I go with the flow D) I make sure it gets done right;
What I long for is: A) fun B) a cause C) peace D) stability;
When someone makes me an unexpected offer, I am most likely to say: A) “O.k.—I'll try it!” B) “Yes! Absolutely.” Or: “No thanks.” C) “Maybe. Good idea.” D) “I'll consider it”;
My initial response to a problem is: A) I experiment with options: Why not try this? B) I act to address it: What can we do now? C) I analyze the background: Why did this happen? D) I scrutinize the result/consequence: How can we deal with this?; and
Primarily, I consider myself to be: A) creative B) decisive C) analytical D) judicious.

The answers to the questionnaire are then tallied into four categories corresponding to the four unique identifiers (e.g., A, B, C and D). The categories are then ordered by the sum of the number of answers that fall into each category. The category with the largest number of answers is assigned as the individual's perceived primary professional style. The individual's perceived primary professional style is the primary professional style that the individual perceives him or her -self as possessing and exhibiting as a professional. The primary professional style is the primary energy element of the individual's professional style.

The category with the second largest number of answers is then correlated to the individual's perceived secondary professional style. The category with the third largest number of answers is then correlated to the individual's perceived tertiary professional style. The category with the least number of answers is then correlated to the individual's perceived quaternary professional style. When the number of answers in each category is the same, the first through fourth perceived professional styles are equally weighted for that individual. When the number of answers in two or three of the categories is the same, then the correlated perceived professional styles associated with those categories are equally weighted for that individual.

The individual optionally answers a second questionnaire. The second questionnaire asks that the questions be answered by the individual based on the individual's perception of the personality he or she exhibits in his or her personal life (i.e., the non-professional personality). Each of the questions has four answers each with a unique identifier, e.g., A, B, C and D. The questions are directed to a variety of categories including, e.g., how others would describe the individual's social persona, the nature of the individual's communication style, what the individual typically contributes to the social group, what the individual likes best about his or herself from a social perspective, what the individual struggles with, what the individual perceives as something that he or she does not like about him or her-self, the individual's then current overall self-perception, the individual's primary nature, what the individual perceives as missing from his or her personal life, and how the individual responds to unexpected offers and problems.

Examples of useful questions and answers for the second questionnaire include:
Socially, most people would describe me as: A) up-beat B) outspoken C) low-key D) down-to-earth;
The element I usually bring to the table is best described as: A) lively B) bold C) philosophical D) to the point;
I tend to be recognized for contributing: A) ideas and excitement B) action and results C) process and planning D) clarity and quality;
What I like best about myself is that I am: A) curious B) passionate C) methodical D) realistic;
What I struggle with is that I am: A) impulsive B) restless C) slow D) introverted;
I can sometimes be too: A) inattentive B) reckless C) meandering D) perfectionist;
I would say that I am generally: A) vivacious B) dynamic C) nurturing D) logical;
The statement that resonates MOST with me at this time: A) I am spontaneous and playful B) I get things done C) I go with the flow D) I make sure it gets done right;
What I long for is: A) fun B) a cause C) peace D) stability;
When someone makes me an unexpected offer, I am most likely to say: A) “O.k.—I'll try it!” B) “Yes! Absolutely.” Or: “No thanks.” C) “Maybe. Good idea.” D) “I'll consider it”;
My initial response to a problem is: A) I experiment with options: Why not try this? B) I act to address it: What can we do now? C) I analyze the background: Why did this happen? D) I scrutinize the result/consequence: How can we deal with this?; and
Primarily, I consider myself to be: A) creative B) decisive C) analytical D) judicious.

The answers to the second questionnaire are then tallied into four categories corresponding to the four unique identifiers (e.g., A, B, C and D). The categories are then ordered by the sum of the number of answers that fall into that category. The category with the largest number of answers is then correlated to the individual's perceived primary personal style.

The category with the second largest number of answers is correlated to the individual's perceived secondary personal style. The category with the third largest number of answers is then correlated to the individual's perceived tertiary personal style. The category with the least number of answers is then correlated to the individual's perceived quaternary personal style. In situations in which the number of answers in each category is the same, then the first through fourth perceived personal styles are equally weighted for that individual. In situations in which the number of answers in two of the categories or three of the categories is the same, then the correlated perceived personal styles associated with those categories are equally weighted for that individual.

The results of the correlation are then analyzed. Analyzing the correlation between the perceived primary professional style and the perceived primary personal style reveals the resonance or lack of resonance in an individual. The perceived primary personal styles of the individual can exhibit resonance (i.e., harmony), lack of resonance (i.e., dissonance), and combinations thereof with each other, and with each other and the various secondary, tertiary and quaternary personality styles. Where there is resonance between all the perceived styles in an individual, there is harmony between all the perceived styles in an individual. Where there is dissonance between any one of the perceived styles of the individual there is imbalance and a lack of harmony in the individual. An individual can utilize the information regarding his or her perceived styles in a variety of ways including, e.g., in interactions with others, to gain insight into him or her-self, and to determine if he or she is suitable for an employment position. Employers can also utilize this information in a variety of ways including, e.g., to determine if the individual is suitable for an employment position, to understand how the individual interacts with others, and to gain insight into how to lead and manage the individual.

Initial Stress Factor Assessment

The Stress Factor is a reactive state of being. Where there is resonance between the primary perceived professional and personal styles, there is harmony both between the perceived styles and within the individual. Where there is dissonance between the primary perceived professional and personal styles there is dissonance, imbalance, and a lack of harmony between the perceived styles and within the individual.

Dissonance between the perceived styles can create a Stress Factor (E-R). The Stress Factor reflects a state of perceived Entrapment without Resolution. Often, when the Stress Factor is high, a person's internal dialogue centers around mental and emotional strategies for maintaining indecision and despair. The Stress Factor is the proactive energy of the perceived professional style plus the proactive energy of the perceived personal style divided by the reactive dimension of the perceived professional style and perceived personal style plus the perceived loss, which can be expressed by the following equation:

Initial Stress Factor (iE-R)=[Y¹+Y²+Z¹+Z²]/[rY×rZ]+X

where Y¹ is the perceived primary professional style (A, B, C or D) i.e. the category that has the most answers,

Y² is the perceived primary personal style (A, B, C or D) i.e. the category that has the most answers,

Z¹ is the perceived secondary professional style (A, B, C or D) i.e. the category with the second most answers,

Z² is the perceived secondary personal style (A, B, C or D) i.e. the category with the second most answers

rY¹ is the dominant reactive dimension obtained from a database of known reactive qualities of the mind-body temperament associated with the perceived primary professional style (Y¹) (The reactive qualities include, e.g., negative qualities, shadow qualities, and combinations thereof.),

rY² is the dominant reactive dimension obtained from a database of known reactive qualities of the mind-body temperament associated with the perceived primary personal style (Y²),

rZ¹ is the dominant reactive dimension obtained from a database of the known reactive qualities associated with the mind-body temperament correlated to the perceived secondary professional style (Z¹), and

rZ² is the dominant reactive dimension obtained from a database of the known reactive qualities associated with the mind-body temperament correlated to the perceived secondary personal style (Z²), and

X is the perceived loss (i.e., the answer to the question, “What I long for is ______”). This question is on both the professional questionnaire and the personal questionnaire and the answer reflects a loss perceived by the individual.

The database of known reactive behavior qualities associated with the mind-body temperaments includes information related to behavior qualities correlated to specific mind-body temperaments. A first mind-body temperament (e.g., Catalyst) exhibits reactive qualities that manifest themselves in behaviors that include, e.g. evasion, irrational risk-taking, self-indulgence, anxious, erratic, impulsive, escapist, shallow, distant, capricious, unreliable and combinations thereof. A second mind-body temperament (e.g., Torchbearer) exhibits reactive qualities that manifest themselves in behaviors that include, e.g., aggressive, belligerent, lashing out, burning out, burning up, inconsiderate, thoughtless, careless, irritable, and combinations thereof. A third mind-body temperament (e.g., Pathfinder) exhibits reactive qualities that manifest themselves in behaviors that include, e.g., denial, emotional fog, depression, easily over-whelmed, head in the sand, confused, codependent, indecisive, and combinations thereof. A fourth mind-body temperament (e.g., Pragmatist) exhibits reactive qualities that manifest themselves in behaviors that include, e.g., rigidity, perfectionism, melancholia, procrastination, hyper-criticism, harsh judgment, and combinations thereof. This information can be included in the database and is useful in the assessment of the individual.

The database optionally also includes information on the action potential of the primary mind-body temperament. When the missing element is identified, the database of known actions that can be taken to address the missing element can be used to identify and suggest actions to be taken.

### Assessed Mind-Body Temperament

The method of analyzing the personality of an individual optionally includes additional methods of obtaining information about an individual's perceived personality styles, methods of determining the individual's assessed mind-body temperaments, methods of determining the order of the individual's mind-body temperaments, and combinations thereof.

Primary Mind-Body Temperament Determination Shapes

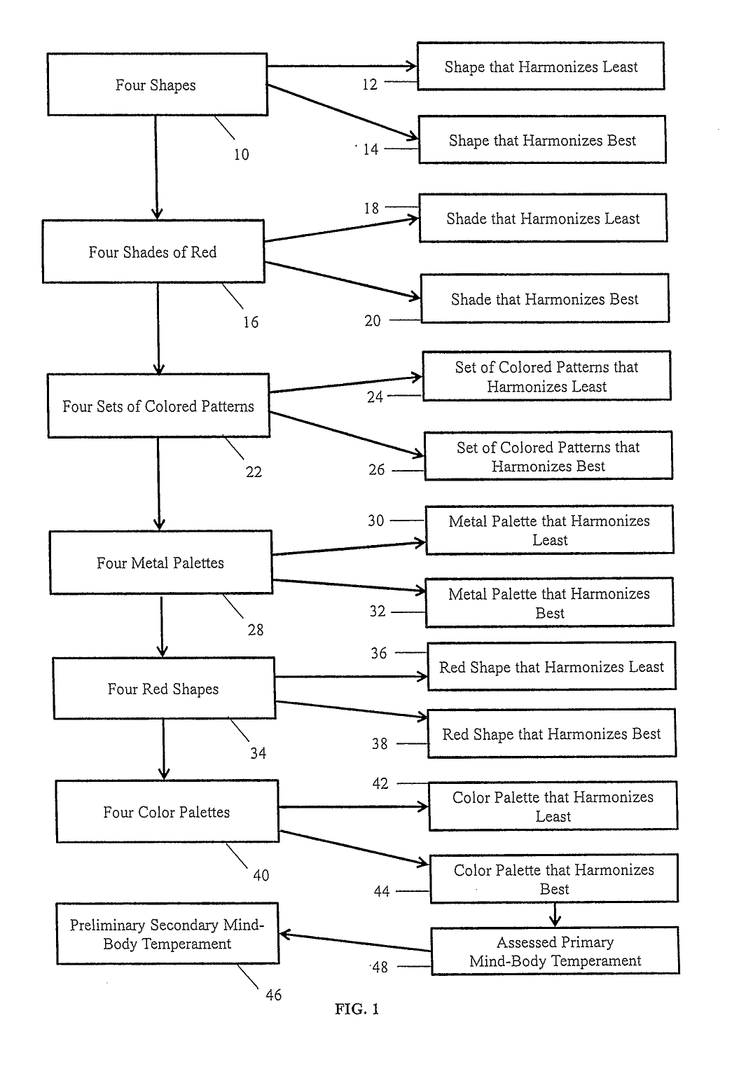

One step in determining an individual's assessed mind-body temperament includes assessing the relationship of the individual's face to four shapes 10, i.e., a circle, a triangle, an oval, and rectangle, as illustrated in FIG. 1. The method includes determining which shape 14 of the four shapes 10 harmonizes best with the individual's face, optionally determining which shape 12 of the four shapes harmonizes least with the individual's face, selecting the shape that harmonizes best 14 with the individual's face, and identifying the mind-body temperament correlated to the selected shape. Assessing the relationship of the individual's face to the shapes and determining which shape harmonizes best with the individual's face includes placing the shapes near the individual's face (e.g., sequentially, simultaneously, and combinations thereof) and observing how the shapes resonate with the individual's face. The observing can include, e.g., having the individual observe his or her reflection in a mirror, having one or more other people observe the individual and providing feedback, and combinations thereof. The mind-body temperament information gained from the other methods disclosed herein (e.g., methods that utilize shades of red, sets of color patterns, metal palettes, red shapes, and color palettes), can be useful in helping to identify the best harmonizing shape.

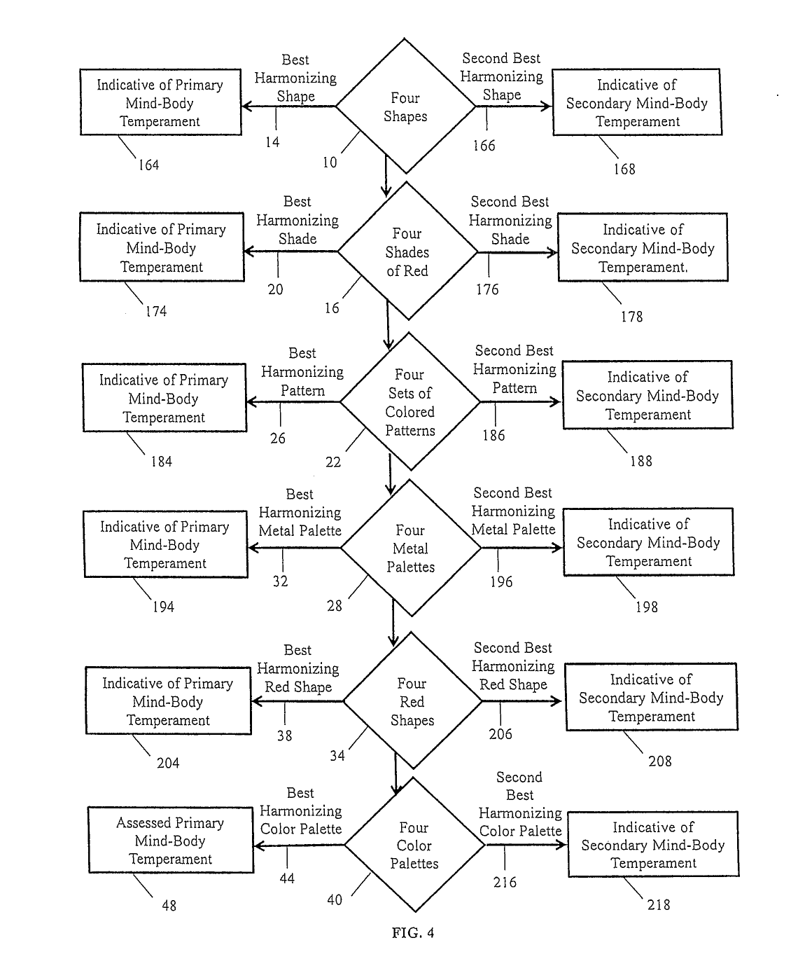

The method optionally includes identifying at least one of the two least harmonizing shapes and the two best harmonizing shapes 14, 166 from the group of at least four shapes 10, setting aside the two least harmonizing shapes, and working with the two best harmonizing shapes 14, 166 to identify the best harmonizing shape 14 and the second best harmonizing shape 166, as illustrated in FIG. 4.

Each shape has been predetermined to correlate with one of the four mind-body temperaments (e.g., Catalyst, Torchbearer, Pathfinder, and Pragmatist). In general, circular (e.g., spiral) shapes are correlated to personality characteristics that include, e.g., bubbly, open, quick, flexible, non-linear, playful, inventive, visionary, unpredictable, upbeat, fun, and combinations thereof. Uneven triangular shapes (e.g., scalene triangles, and sunglasses that have generally triangular lenses that extend from the face toward the sides of the head of wearer) are correlated to personality characteristics that include, e.g., fast, forceful, switching, doing it now, dynamic, dominant, agenda-driven, on a mission for a cause, and combinations thereof. Oval shapes are correlated to personality characteristics that include, e.g., yielding, considerate, non-linear, soft, diplomatic, patient, investigative, planner, and combinations thereof. Rectangular shapes are correlated to personality characteristics that include, e.g., steady, solid, linear, doing it right, questioning, pragmatic, precise, serious, and combinations thereof.

Specific examples of useful shape-mind-body temperament correlations include, e.g., a circular shape correlated to Catalyst, an uneven triangular shape correlated to Torchbearer, an oval shape correlated to Pathfinder, and a rectangular shape correlated to Pragmatist.

When the shape that harmonizes best with the individual's face is determined it can be cross-referenced to its correlated mind-body temperament. The mind-body temperament associated with the shape is then noted, identified as indicative of the primary mind-body temperament of the individual 164, and optionally temporarily ascribed to the individual as his or her primary mind-body temperament. When the method has identified the two best harmonizing shapes 14, 166, the remaining shape 166 (i.e., the shape that harmonizes the least with the individual's face out of the two best harmonizing shapes) is indicative of the secondary mind-body temperament of the individual 168. Once this information is obtained, it optionally is stored for future use.

The method can be carried out using a variety of objects that exhibit the general specified shapes including, e.g., sunglasses. Preferably the shapes are embodied in articles that can be worn on the face or head.

In one embodiment, each of the four shapes is in the form of four different pairs of sunglasses, each pair of sunglasses generally exhibiting one of the four shapes. Assessing the relationship of the individual's face to four shapes includes placing the sunglasses on the face of the individual and then determining which one of the individual's face and the sunglasses is seen first by an observer. In other words, determining whether the face is dominated by the sunglasses (i.e., the sunglasses are seen first) or whether the face is in harmony with the sunglasses (i.e., the face is seen first).

If the face is not in harmony with the shape or if there is some doubt as to whether it is in harmony, the method can be repeated with all or some of the remaining shapes until a pair of sunglasses is selected for which the individual's face is seen first by an observer and the sunglasses are seen second.

Shades of Red

The method of analyzing the personality of an individual alternatively or additionally includes determining which shade of red 20 from a group of at least four shades of red 16 harmonizes best with the individual's face, optionally determining which shade of red 18 from the group of at least four shades of red 16 harmonizes least with the individual's face, selecting the shade of red that harmonizes best 20 with the individual's face, and correlating the selected shade of red to a first mind-body temperament, as illustrated in FIG. 1. The determination as to which shade of red from the group of at least four shades of red harmonizes best with the individual's face includes placing the shades of red near the individual's face and observing how the shades of red resonate with the individual's face. The observing can include, e.g., having the individual observe him or her-self in a mirror, having one or more other people observe the individual and providing feedback, and combinations thereof. The mind-body temperament information gained from the other methods disclosed herein (e.g., methods that utilize shapes, sets of color patterns, metal palettes, red shapes, and color palettes), is useful in helping to identify the best harmonizing shades of red.

The method optionally includes identifying at least one of the two least harmonizing shades of red and the two best harmonizing shades of red, 20, 176 from the group of at least four shades of red 16, setting aside the two least harmonizing shades of red, and working with the two remaining shades of red 20, 176 (i.e., the best harmonizing shades of red), to identify the best harmonizing shade of red 20 and the second best harmonizing shape 176, as illustrated in FIG. 4. Optionally the two shades of red that harmonize the least are noted.

After the shade of red that harmonizes best 20 with the individual's face is determined it can be cross-referenced to its correlated mind-body temperament. The mind-body temperament associated with the shade of red is then noted and, optionally, temporarily ascribed to the individual as indicative of the individual's primary mind-body temperament 174. When the two best harmonizing shades of red 20, 176 have been identified, the remaining shade of red 176 (i.e., the shade of red that harmonizes the least with the individual's face out of the two best harmonizing shades of red) is indicative of the secondary mind-body temperament 178 of the individual. Once this information is obtained, it optionally is stored for future use.

A variety of shades of red are useful in the method including, e.g., shades of red that are in the purple spectrum, shades of red that are in the orange spectrum, shades of red that are in the brown spectrum, shades of red that are in the ruby spectrum, shades of red that are in the pink spectrum, shades of red that are in the yellow spectrum, and combinations thereof. Useful commercially available shades of red in the yellow, burnt red, burgundy and ruby spectra of red are available from a variety of sources including, e.g., from Pantone LLC (Carlstadt, N.J.).

The shade of red used in the method has been predetermined to correlate with a mind-body temperament. In general, tangerine shades of red and shades of red generally in the yellow spectrum are correlated to personality characteristics that include, e.g., warm, fresh, crisp, high energy, lively, charismatic, social and combinations thereof. Burnt shades of red and shades of red in the orange spectrum are correlated to personality characteristics that include, e.g., warm, burnished, high velocity, energizing, exhausting, and combinations thereof. Burgundy shades of red spectrum and shades of red in the purple spectrum are correlated to personality characteristics that include, e.g., cool, subdued, low-key, supporting, calming, moderate, and combinations thereof. Ruby shades of red and reds in the true red spectrum are correlated to personality characteristics that include, e.g., cool, pure, intense energy, unconditional, constant, and combinations thereof.

Specific examples of useful shades of red-mind-body temperament correlations include a tangerine shade of red correlated to Catalyst, a burnt red (e.g., brick red) shade of red correlated to Torchbearer, a burgundy shade of red correlated to Pathfinder, and a ruby shade of red correlated to Pragmatist.

Sets of Colored Patterns

The method of analyzing the personality of an individual alternatively or additionally includes determining which set 26 of colored patterns selected from a group consisting of at least four sets of colored patterns 22 harmonizes best with the individual's face, optionally determining which set 24 of the four sets of colored patterns 22 harmonizes least with the individual's face, selecting the set of colored patterns that harmonizes best 26 with the individual's face, and correlating the selected set of colored patterns to a first mind-body temperament, as illustrated in FIG. 1. The determination as to which set of colored patterns harmonizes best with the individual's face includes placing a set of colored patterns near the individual's face and observing how the colored patterns resonate with the individual's face. The observation can be made by the individual observing him or her -self in a mirror, one or more other people observing the individual and providing feedback, and combinations thereof The mind-body temperament information gained from the other methods disclosed herein (e.g., methods that utilize the shapes, shades of red, metal palettes, red shapes, and color palettes), is useful in helping to identify the best harmonizing sets of colored patterns.

The method optionally includes identifying at least one of the two best harmonizing sets of colored patterns 26, 186 and the two least harmonizing sets of colored patterns, from the group of at least four sets of colored patterns 22, setting aside the two least harmonizing sets of colored patterns, and working with the two best harmonizing sets of colored patterns 26, 186 to identify the best harmonizing set of colored patterns 26 and the second best harmonizing set of colored patterns 186, as illustrated in FIG. 4.

Each set of colored patterns includes a number of colored patterns including, e.g., at least two, at least three, or even at least four colored patterns. The sets of colored patterns can be constructed and arranged in any suitable manner including, e.g., a series of rectangular portions each having the same dimensions and including a piece of fabric having similar colors or in the same color family but a different pattern, a series of strips, dots, spots, dashes, and combinations thereof of different patterns.

Useful sets of colored patterns include, e.g., strips of patterned components (e.g., strips of different color patterns and strips of different fabric patterns), wheels of colored patterns, and combinations thereof.

The colored patterns can provide information on the individual's instinctive intelligence (e.g., impulse), and potential for action. Each set of colored patterns has been predetermined to correlate to a mind-body temperament. In general, unstructured (e.g., random), variable, inconsistent, and unpredictable colored patterns are correlated to mind-body temperaments that exhibit an unstructured and unpredictable nature (e.g., sunny, optimistic, visionary, artistic, rash, spontaneous and combinations thereof). Jagged (e.g., lightning bolts), complex and uneven colored patterns (e.g., animal prints) are correlated to mind-body temperaments that exhibit a jagged, complex and multidirectional but focused nature (e.g., passionate, dramatic, bold, decisive, abrupt, staccato, and combinations thereof). Blending and flowing (e.g., infinity symbol and water) colored patterns are correlated to mind-body temperaments that exhibit a flowing and blended nature (e.g., graceful, sensual, gentle, depth, analytical, indecisive, longwinded, and combinations thereof). Predictable, structured, balanced, and linear colored patterns are correlated to mind-body temperaments that exhibit predictable, structured and linear nature (e.g., clear, predictable, composed, rational, discerning, reflective, perfectionist, critical, and combinations thereof).

Specific examples of useful colored pattern-mind-body temperament correlations include, e.g., unstructured and unpredictable-based colored patterns correlated to Catalyst, jagged and complex-based colored patterns correlated to Torchbearer, blending and flowing-based colored patterns correlated to Pathfinder, and structured and predictable-based colored patterns correlated to Pragmatist.

When the set of colored patterns that harmonizes best 26 with the individual's face is determined, it is then cross-referenced to its correlated mind-body temperament. The mind-body temperament associated with the set of colored patterns is then noted, and, optionally, temporarily ascribed to the individual as the individual's primary mind-body temperament. The mind-body temperament correlated to the set of colored patterns that harmonizes best with the individual's face provides information and insight into the likely assessed primary mind-body temperament of the individual 184. Once this information is obtained, it optionally is stored for future use.

When the two best sets of colored patterns have been identified 26, 186, the remaining set of colored patterns 186 (i.e., the set of colored patterns that harmonizes the least with the individual's face out of the two best harmonizing sets of colored patterns) is indicative of the secondary mind-body temperament of the individual 188. Once this information is obtained, it optionally is stored for future use.

Metal Palettes

The method of analyzing the personality of an individual alternatively or additionally includes determining which metal palette 32 selected from a group of at least four metal palettes 28 harmonizes best with the individual's face, optionally determining which metal palette 30 of the four metal palettes 28 harmonizes least with the individual's face, selecting the metal palettes that harmonizes best 32 with the individual's face, and correlating the selected metal palettes to a first mind-body temperament, as illustrated in FIG. 1. The determination as to which metal palette harmonizes best with the individual's face includes placing a metal palette near the individual's face and observing how the metal palette resonates with the individual's face. The observation can be made by the individual observing him or her -self in a mirror, one or more other people observing the individual and providing feedback, and combinations thereof. The metal palette that harmonizes best with the individual's face is noted.

The method optionally includes identifying at least one of the two best harmonizing metal palettes 32, 196 and the two least harmonizing metal palettes, from the group of at least four metal palettes 28, setting aside the two least harmonizing metal palettes, and working with the two best harmonizing metal palettes 32, 196 to identify the best harmonizing metal palettes 32 and the second best harmonizing shape 196, as illustrated in FIG. 4. The mind-body temperament information gained from the other methods disclosed herein (e.g., methods that utilize the shapes, shades of red, sets of color patterns, red shapes, and color palettes), is useful in helping to identify the two best harmonizing metal palettes. The two metal palettes that correlate to the two mind-body temperaments determined using the method that utilizes the sets of colored patterns, for example, can be selected as the best harmonizing metal palettes for use in the method.

Each metal palette used in the method can includes a plurality of sections and each section can include a metallic color and can be different from each other section. Each metal palette includes at least two, at least three, or even at least four metallic colors. The metallic colors can be in any suitable form including, e.g., a plurality of metal strips, dots, spots, dashes, and combinations thereof. Useful metallic colors include, e.g., colors of the transition metals (e.g., silver, platinum, gold, copper, nickel, zinc, and palladium), colors of the post transition metals (e.g., lead, tin, aluminum, and combinations thereof), and combinations of metals including e.g., bronze, brass, pewter, and combinations thereof. The metals can be brushed, polished, satin-finished, dull, and combinations thereof. Each metal palette can include, e.g., a number of sections (e.g., rectangular sections) each having the same dimensions and including the similar metallic colors.

Useful sets of metallic colors include, e.g., strips of metallic components (e.g., metallic colors, metallic fabrics, metallic nail polishes, metallic paints, pieces of metal, and combinations thereof).

Each metal palette has been predetermined to correlate to a mind-body temperament. In general, gold metals are correlated to social, outgoing, spontaneous, up-lifting and energy mind-body temperaments, bronze and copper colored dull metals are correlated to driven, dramatic, results-oriented, and fiery mind-body temperaments, brushed and dull pewter metals are correlated to low-key, analytical, investigative, nurturing and gentle mind-body temperaments, and shiny silver and platinum metals are correlated clear, reflective, discerning, precise, and judicious mind-body temperaments.

Specific examples of useful metal palette-mind-body temperament correlations include a shiny metallic gold palette correlated to Catalyst, a brushed or dull metallic bronze or copper palette correlated to Torchbearer, a brushed or dull metallic pewter palette correlated to Pathfinder, and a shiny metallic silver palette correlated to Pragmatist.

When the metal palette that harmonizes best with the individual's face 32 is determined, it can be cross-referenced to its corresponding mind-body temperament. The mind-body temperament associated with the metal palette is then noted. At this stage, the mind-body temperament correlated to the selected metal palette that harmonizes best 32 with the individual's face provides information and insight into the likely assessed primary mind-body temperaments of the individual 194. Once this information is obtained, it optionally is stored for future use.

When the two best harmonizing metal palettes have been identified 32, 196, the remaining metal palette 196 (i.e., the metal palette that harmonizes the least with the individual's face out of the two best harmonizing metal palette) is indicative of the secondary mind-body temperament of the individual 198. Once this information is obtained, it optionally is stored for future use.

Red Shapes

The method of analyzing the personality of an individual alternatively or additionally includes determining which red shape 38 from a group of at least four red shapes 34 harmonize best with the individual's face, optionally determining which red shape 36 of the four red shapes 34 harmonizes least with the individual's face, selecting the red shape that harmonizes best 38 with the individual's face, and correlating the selected red shape to a first mind-body temperament, as illustrated in FIG. 1. The determination as to which red shape harmonizes best with the individual's face includes placing a red shape near the individual's face and observing how the shape and red color resonate with the individual's face. The observation can be made by the individual observing him or her -self in a mirror, one or more other people viewing the individual and providing feedback, and combinations thereof. The information gained from the other methods disclosed herein (e.g., methods that utilize the shapes, red shades, sets of color patterns, metal palettes, and colored palettes), is useful in helping to identify the best harmonizing red shape(s).

The method optionally includes identifying at least one of the two best harmonizing red shapes 38, 206 and the two least harmonizing red shapes, from the group of at least four red shapes 34, setting aside the two least harmonizing red shapes, and working with the two best harmonizing red shapes 38, 206 to identify the best harmonizing red shape 38 and the second best harmonizing shape 206, as illustrated in FIG. 4.

The four red shapes have the general shape of a circle, an oval, an uneven triangle (e.g., a scalene triangle), and a rectangle. The shapes have the color red on at least one surface thereof. The shade of red on each shape is different. The shades of red on the shapes preferably correspond to the shades of red utilized in the method that utilizes shades of red. The red color can be present on the shape in a variety of forms including, e.g., fabric, nail polish, paint, paper, ink, and combinations thereof. Suitable red shapes include, e.g., a tangerine red circle, a burnt red uneven triangle, a burgundy red oval, and a ruby red rectangle.

Each red shape has been predetermined to correlate with a mind-body temperament. In general, each red shape is correlated to the personality characteristics that are correlated to the shapes (as described in detail with regard to the shapes method) and the personality characteristics that are correlated to the shades of red (as described in detail with regard to the shades of red method). Specific examples of useful red shape-mind-body temperament correlations include a tangerine red circular shape correlated to Catalyst, a burnt red scalene triangular shape correlated to Torchbearer, a burgundy red oval shape correlated to Pathfinder, and a ruby red rectangular shape correlated to Pragmatist.

When the red shape that harmonizes best 38 with the individual's face is determined, it can be cross-referenced to its correlated mind-body temperament. The mind-body temperament correlated to the red shape 38 provides information and insight into the likely assessed primary mind-body temperament of the individual 204.

When the two best harmonizing red shapes 38, 206 have been identified, the remaining red shape 206 (i.e., the red shape that harmonizes the least with the individual's face out of the two best harmonizing red shapes) is indicative of the secondary mind-body temperament of the individual 208. Once this information is obtained, it optionally is stored for future use.

Color Palette

The method of analyzing the personality of an individual alternatively or additionally includes determining which color palette 44 selected from a group of at least four color palettes 40 harmonizes best with the individual's face, optionally determining which color palette 42 of the at least four color palettes 40 harmonizes least with the individual's face, selecting the set of color palettes that harmonizes best 44 with the individual's face, and correlating the selected set of color palettes to a first mind-body temperament, as illustrated in FIG. 1. The determination as to which color palette harmonizes best with the individual's face includes placing a color palette near the individual's face and observing how the colors of the palette resonate with the individual's face. The observation can be made by the individual observing him or her-self in a mirror, one or more other people observing the individual and providing feedback, and combinations thereof. The information gained from the other methods disclosed herein (e.g., methods that utilize the shapes, shades of red, sets of color patterns, metal palettes, and red shapes) is useful in helping to identify which color palettes will likely be the best harmonizing color palettes.

The method optionally includes identifying at least one of the two least harmonizing color palettes and the two best harmonizing color palettes 44, 216 from the group of at least four color palettes 40, setting aside the two least harmonizing color palettes, and working with the two best harmonizing color palettes 44, 216 to identify the best harmonizing color palette 44 and the second best harmonizing color palette 216, as illustrated in FIG. 4.

Useful color palettes include, e.g., a plurality of color strips, dots, spots, dashes, and combinations thereof. Each color strip can include, e.g., a plurality of colored sections that are different from each other. Each color palette preferably includes at least two, at least three, at least four, at least 10 or even at least 15 colors. Useful color palettes include, e.g., color fan decks (e.g., paint color fan decks and nail color fan decks), paint color matrixes, color strips, color wheels, and combinations thereof.

Useful color palettes are commercially available under the trade designations CATALYST color palette, TORCHBEARER color palette, PATHFINDER color palette and PRAGMATIST color palette, all of which are available from the Alpha Element Institute (Excelsior, Minn.).

Each color palette is predetermined to correlate with a different mind-body temperament. At least four color palettes have been predetermined to correlate to each of the four different mind-body temperaments. In general, spring color-based color palettes include bright colors and are correlated to personality characteristics that include, e.g., wonder, extroverted, idea oriented and combinations thereof. Fall color-based color palettes include rustic colors and are correlated to personality characteristics that include, e.g., dramatic, transformative, extroverted, action oriented, and combinations thereof. Summer color-based color palettes are correlated to personality characteristics that include, e.g., low-key, diplomatic, supporting, introverted, process oriented, and combinations thereof. Winter color-based color palettes include intense colors and are correlated to personality characteristics that include, e.g., intense, stable, introverted, quality oriented, and combinations thereof.

Specific examples of useful color palette-mind-body temperament correlations include spring color-based color palette correlated to Catalyst, fall color-based color palette correlated to Torchbearer, summer color-based color palette correlated to Pathfinder, and winter color-based color palette correlated to Pragmatist.

When the color palette that harmonizes best 44 with the individual's face is determined, it can be cross-referenced to its correlated mind-body temperament. The mind-body temperament associated with the selected color palette is then noted. At this stage, the mind-body temperament correlated to the color palette that harmonizes best 44 with the individual's face is determined to be the assessed primary mind-body temperament of the individual 48 (i.e., the Alpha Element of the individual's personality) and reflects the predominant instinct of the individual. Once this information is obtained, it optionally is stored for future use.

When the two best harmonizing color palettes 44, 216 have been identified, the remaining color palette 216 (i.e., the color palette that harmonizes the least with the individual's face out of the two best harmonizing color palettes) is indicative of the secondary mind-body temperament 218 of the individual (i.e., the e-Beta Element of the individual's personality). Once this information is obtained, it optionally is stored for future use.

Secondary Mind-Body Temperament Determination

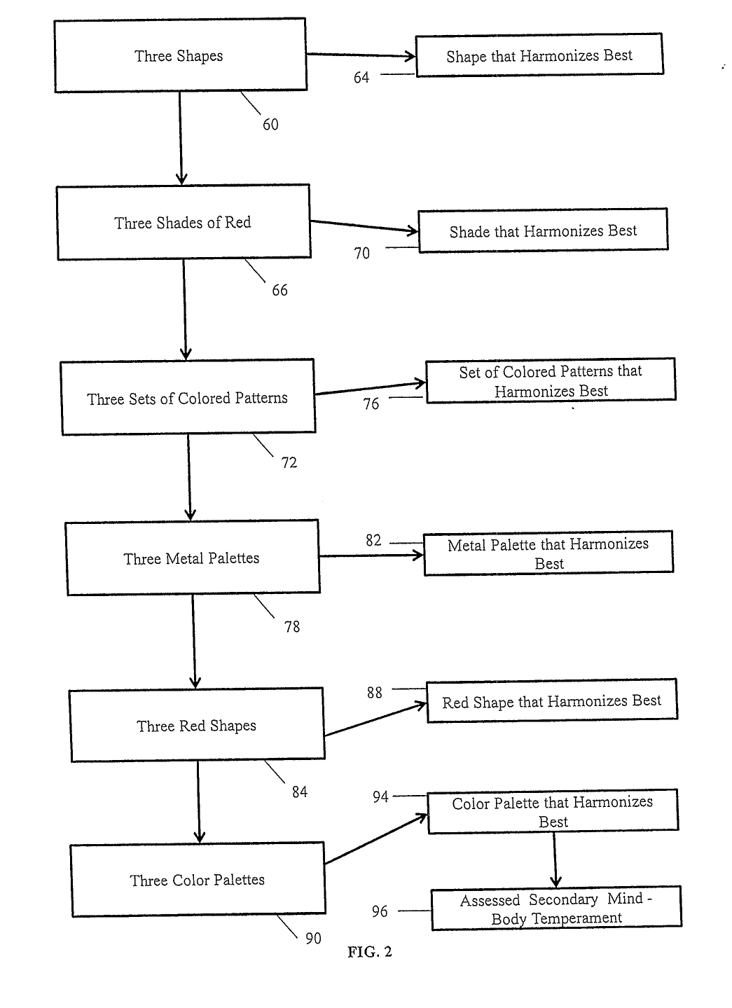

The assessed secondary mind-body temperament of the individual is determined according to the above methods of analyzing the personality of an individual by repeating at least one of the methods using the remaining three shades of red, color patterns, metal palettes, red shapes and color palettes, as illustrated in FIG. 2. In other words, the shapes, shades of red, sets of colored patterns, metal palettes, red shapes and color palettes correlated to the assessed primary mind-body temperament of the individual are removed from their respective groups and the remaining three shapes 60, shades of red 66, sets of colored patterns 72, metal palettes 78, red shapes 84, and color palettes 90 are then used in the methods. The best harmonizing shape 64, shade of red 70, set of colored patterns 76, metal palette 82, and red shape 88 of this subset are indicative of the secondary mind-body temperament. When the best harmonizing color palette 94 is determined, it is cross-referenced to its correlated mind-body temperament and that mind-body temperament is assigned as the individual's assessed secondary mind-body temperament 96.

Tertiary and Quaternary Mind-Body Temperament Determinations

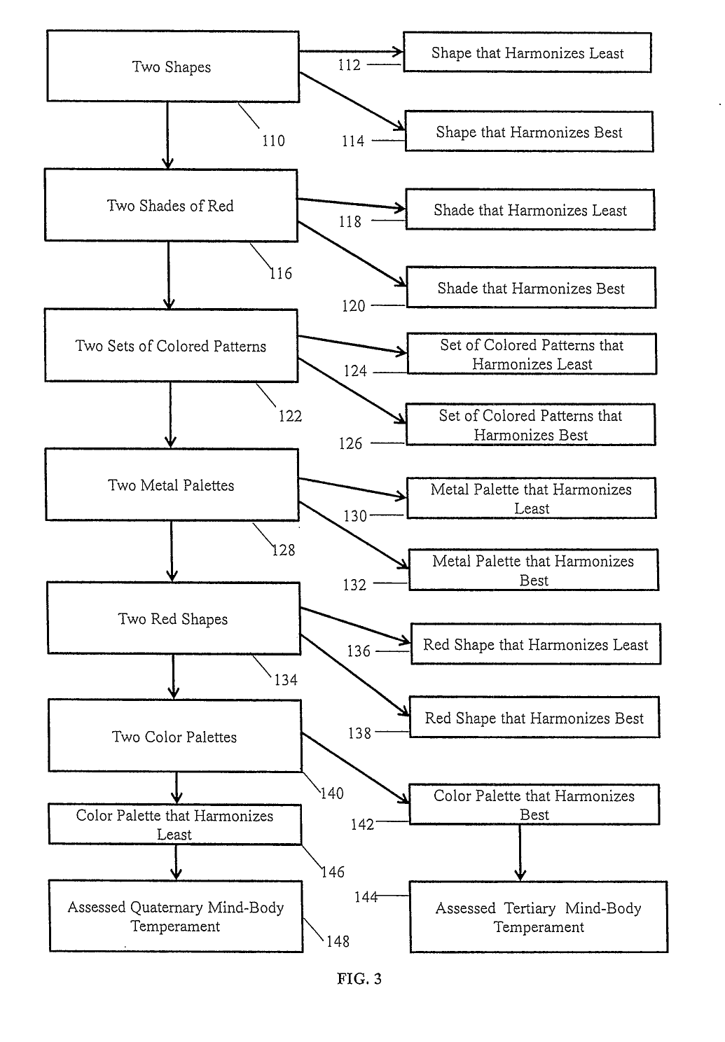

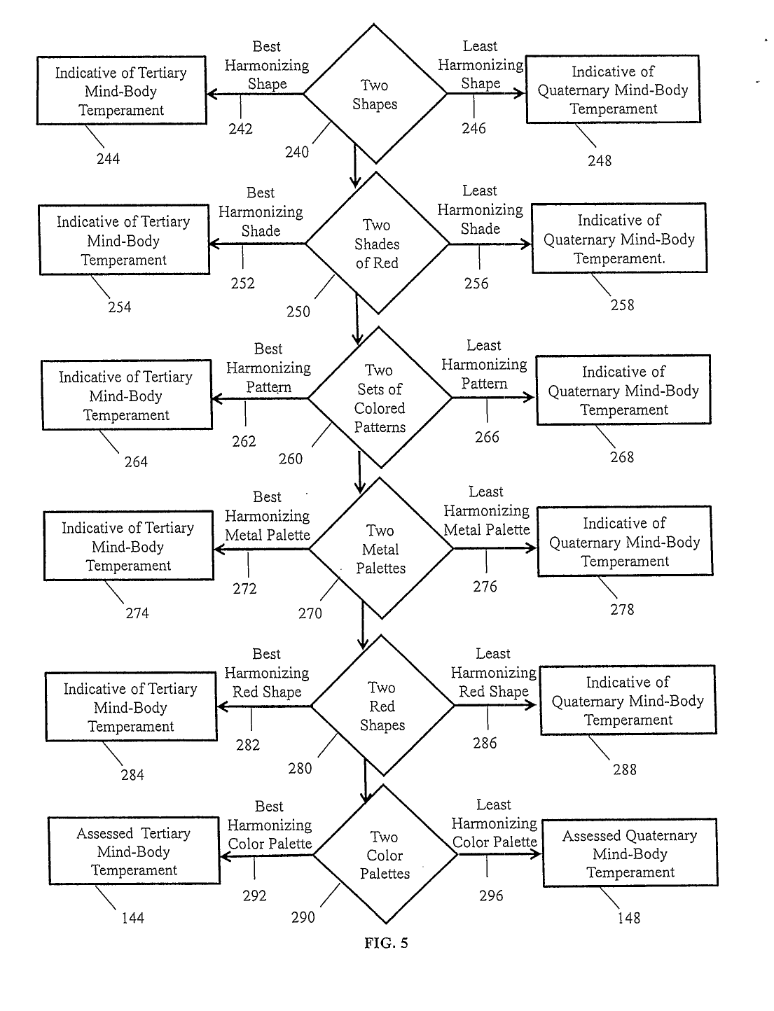

The assessed tertiary 144 and quaternary 148 mind-body temperaments of the individual are determined after the secondary mind-body temperament is determined, as illustrated in FIGS. 3 and 5. To determine the tertiary 144 and quaternary 148 mind-body temperaments of the individual, the above methods of analyzing the personality of an individual are repeated using the remaining two shapes 110, shades of red 116, sets of colored patterns 122, metal palettes 128, red shapes 134, and color palettes 140. In other words, the shapes, shades of red, colored patterns, metal palettes, red shapes and color palettes correlated to the primary and secondary mind-body temperament of the individual are removed from their respective groups and the remaining two shapes 110 shades of red 116, sets of colored patterns 122, metal palettes 128, red shapes 134, and color palettes 140 are used in the method.

The methods are then utilized to determine the best harmonizing shape 114, shade of red 120, set of colored patterns 26, metal palette 132, and red shape 138. The results of these methods are indicative of the tertiary mind-body temperament 244, 254, 264, 274, 284. When the best harmonizing color palette 292 is determined, it is cross-referenced to its correlated mind-body temperament and that mind-body temperament is assigned as the individual's assessed tertiary mind-body temperament 144. The tertiary mind-body temperament 144 corresponds to an intellectual energy element of the individual's personality and is alternately referred to herein as the i-Beta Element.

The remaining shape 246, shade of red 256, set of colored patterns 266, metal palette 276, red shape 286 and color palette 296 are all indicative of the remaining mind-body temperament, which is ascribed to the individual as the individual's assessed quaternary mind-body temperament 148. The quaternary mind-body temperament 148 corresponds to the insight energy element of the individual's personality and is alternately referred to herein as the Omega Element.

Alpha Element Profile

The individual is then provided with a profile (e.g., an Alpha Element Profile), which sets forth an analysis and summary of the different energy elements of the individual's personality and the order of the mind-body temperaments of the individual (i.e., their Alpha Element type). The profile can also identify the overarching mind-body temperament of the individual, which is the instinctive (i.e., Alpha) element of the individual, and the underlying mind-set of the individual, which is the intellectual (i.e., i-Beta) element of the individual. Each of the energy elements (i.e., Alpha, e-Beta, i-Beta, and Omega) is further correlated to the classical elements (i.e., air, fire, water, and earth, respectively), the states of matter (i.e., gas, fire, liquid, and solid, respectively), and the seasons (i.e., spring, fall, summer, and winter, respectively). The profile optionally provides a four letter identifier corresponding to the order of the classical elements in that individual. For example, an individual whose Alpha element is water (W), e-Beta element is fire (F), i-Beta element is air (A), and Omega element is earth (E), is ascribed the overarching mind-body temperament of a Pathfinder and the mindset of a Catalyst and the four letter identifier WFAE.

The format of the Alpha Element Profile can be configured in any useful configuration. In some embodiments, the Alpha Element Profile includes a detailed analysis of personality, strengths and challenges. Additionally, in some embodiments, the Alpha Element Profile includes strategies and plans for dealing with particular situations, for accelerated self-improvement, for achieving harmony between the energy elements including, e.g., between the primary mind-body temperament and the intellectual and emotional mind-body temperaments, for balancing elements of lifestyle goals, determining if an employment position is well suited to the individual, determining which factors are important for career choice decision making, and combinations thereof.

The profile can also provide guidance to assist the individual in understanding his or her own energy field including his or her Alpha, Beta and Omega elements, leadership styles (e.g., self-leadership and leadership of others) including, e.g., impact on others and interacting with others, understanding with which energy elements the individual works best, identifying and understanding the negative behaviors associated with their mind body temperaments, developing mechanisms to overcome the negative behaviors, practicing mental-emotional agility and resilience along with positive behaviors and go-to strategies for achieving dynamic mind-body cohesion and flexibility and control of their reactive states, and combinations thereof.

The profile can also provide information to the individual as to the fundamental colors and patterns in the color palette of their Alpha Element type including, e.g., colors and patterns that resonate best with the individual (as determined by the methods disclosed herein). The knowledge of these colors and color patterns can be used by the individual to create a physical environment that supports the optimal energy balance of their Alpha Element Profile, such as color and pattern selection for clothing, hairstyle, house decorating, symbolism in mental/guided imagery, and combinations thereof.

The actual Stress Factor (E-R) of the individual also can be evaluated based on the assessed mind-body temperaments. When the mind-body temperaments are known, the Stress Factor is defined as:

Stress Factor (E-R)=Y+Z/rY×rZ+X

where Y is the primary mind-body temperament (i.e., Alpha element),

Z is the secondary mind-body temperament (i.e., i-Beta element),

rY is the dominant reactive dimension obtained from a database of known reactive qualities associated with the primary mind-body temperament (Y),

rZ is the dominant reactive dimension obtained from a database of the known reactive qualities associated with the secondary mind-body temperament (Z), and

X is as defined above with respect to the initial E-R.

The profile can include information derived from the E-R to provide guidance to the individual with respect to a variety of aspects of the individual that are impacted by the individual's E-R including, e.g., action potential of the individual's primary mind-body temperament, identification of the individual's missing element and the actions that can be taken to address the missing element, the nature of the negative behaviors correlated to the instinctive energy (i.e., primary mind-body temperament) and cerebral energy (i.e., tertiary mind-body temperament) of the individual, and combinations thereof.

In some embodiments, the method is conveniently practiced on an electronic device that includes a visual display and an interactive component including, e.g., an interactive television, a computer, a tablet, a smart phone, a calculator, and combinations thereof. The electronic device can be any one of a variety of configurations including, e.g., standalone, connected (e.g., directly or indirectly including, e.g., through a wireless connection) to a computer network (e.g., a local area network (LAN), the World Wide Web (i.e., the Internet), and combinations thereof), and combinations thereof.

In one embodiment of the method executed on an electronic device, the questions and answer choices are presented on a visual display for viewing by the individual, the individual selects an answer from the four choices, and the results are tallied by the device. The device then generates a report (e.g., a profile) that reflects the results of the mind-body temperament determinations. The results from the methods that utilize the shapes, shades of red, sets of color patterns, metal palettes, red shapes and color palettes can be input into a database, and an individual profile can be generated based upon the order and nature of the mind-body temperaments. In some embodiments, the database includes information such that when information as to a mind-body temperament is queried, information is provided that describes the characteristics of that temperament and the impact that one or more of the other mind-body temperaments has on the queried mind-body temperament. When the database is queried regarding a negative behavior for a particular mind-body temperament, for example, a report can be generated that describes the positive behaviors (e.g., proactive actions, mantras, goals, and activities), visual icons, reframing tools and other cognitive techniques, and combinations thereof that can be used to balance the individual's energy in light of the four elemental components of the mind-body temperament of the individual. When the missing element is identified, a query of the database can generate a report that identifies actions and strategies that can be taken to obtain the missing element.

Other embodiments are within the claims. Although the methods have been described as occurring in a certain order, a personality can be analyzed utilizing any one or more of the methods in any order. The elements of an individual's personality can be analyzed using a single method or any combination of the methods disclosed herein.

All references referred to herein are incorporated herein in their entirety to the extent they do not conflict with the statements herein.

What is claimed is:

1. A method of analyzing the personality of an individual, the method comprising:
obtaining a first set of data pertaining to a first professional style of the individual;
obtaining a second set of data pertaining to a second personal style of the individual;
correlating the first set of data with at least one mind-body temperament selected from a group consisting of at least four different mind-body temperaments;
correlating the second set of data with at least one mind-body temperament selected from the group of at least four different mind-body temperaments; and
analyzing the correlation between the at least one mind-body temperament associated with the first set of data and with the at least one mind-body temperament associated with the second set of data.

2. The method of claim 1, wherein the first set of data comprises responses to a first questionnaire and the second set of data comprises responses to a second questionnaire.

3. The method of claim 1 further comprising determining the degree to which the first set of data corresponds to each of the four mind-body temperaments, and determining the degree to which the second set of data corresponds to each of the four mind-body temperaments.

4. The method of claim 1 further comprising assessing the stress factor of the individual.

5. A method of analyzing the personality of an individual, the method comprising:
assessing the relationship of the individual's face to a group of at least four shapes, the four shapes comprising a circular shape, an oval shape, triangular shape, and a rectangular shape;
determining which one of the four shapes harmonizes best with the individual's face;
selecting the shape that harmonizes best with the individual's face; and
identifying the mind-body temperament correlated to the selected shape, the correlation of the mind-body temperament and the selected shape having been predetermined.

6. The method of claim 5 further comprising determining which one of the four shapes harmonizes the least with the individual's face.

7. The method of claim 5, wherein the shape is in the form of a pair of sunglasses

8. The method of claim 7, wherein the assessing comprises placing the sunglasses on the face of the individual, and the determining comprises determining which item of the group consisting of the individual's face and the sunglasses is seen first by an observer.

9. A method of analyzing the personality of an individual, the method comprising:
determining which shade of red from a group of at least four shades of red harmonizes best with the individual's face;
selecting the shade of red that that harmonize best with the individual's face; and
identifying the mind-body temperament correlated to the selected shade of red, the correlation of the mind-body temperament to the selected shade of red having been predetermined.

10. A method of analyzing the personality of an individual, the method comprising:
determining which set of colored patterns selected from a group of at least four sets of colored patterns harmonize best with the individual's face;
selecting the set of colored patterns that harmonize best with the individual's face; and
identifying the mind-body temperament correlated to the set of colored patterns, the correlation of the mind-body temperament and the selected set of colored patterns having been predetermined.

11. A method of analyzing the personality of an individual, the method comprising:
determining which metal palette selected from a group of at least four metal palettes harmonizes best with the individual's face, each metal palette comprising a plurality of sections, each section comprising a metallic color and being different from each other section;
selecting the metal palette that harmonizes best with the individual's face; and
identifying the mind-body temperament correlated to the selected metal palette, the correlation of the mind-body temperament and the selected metal palette having been predetermined.

12. A method of analyzing the personality of an individual, the method comprising:
determining which red shape selected from a group of at least two red shapes harmonizes best with the individual's face, each red shape comprising at least one of a circular shape, an oval shape, a triangular shape, and a rectangular shape, and having a different shape;
selecting the selecting the red shape that harmonizes best with the individual's face; and
identifying the mind-body temperament correlated to the selected red shape, the correlation of the mind-body temperament and the selected red shape having been predetermined.

13. A method of analyzing the personality of an individual, the method comprising:
determining which color palette selected from a group of at least two color palettes harmonizes best with the individual's face, each color palette comprising a plurality of colored components, each colored component comprising a plurality of sections, each section comprising a color that is different from the color of each other section;
selecting the color palette that harmonizes best with the individual's face; and
identifying the mind-body temperament correlated to the selected color palette, the correlation of the mind-body temperament and the selected color palette having been predetermined.

14. The method of claim 13, wherein the mind-body temperament correlated to the selected color palette comprises the primary mind-body temperament of the individual.

15. The method of claim 14 further comprising determining the secondary mind-body temperament of the individual.

16. The method of claim 15 further comprising determining the tertiary mind-body temperament of the individual.

17. The method of claim 16 further comprising determining the quaternary mind-body temperament of the individual.

18. The method of claim 15, wherein the secondary mind-body temperament comprises an emotional element of the personality of the individual.

19. The method of claim 16, wherein the tertiary mind-body temperament corresponds to an intellectual element of the personality of the individual.

20. The method of claim 17, wherein the quaternary mind-body temperament corresponds to the insight element of the personality of the individual.

21. A method of determining the tertiary and quaternary mind-body temperaments of the individual, the method comprising the method of claim 13, wherein the group of color palettes comprises at least four color palettes, the method further comprising
determining which two color palettes from the group of color palettes harmonize the least with the individual's face;
selecting the two color palettes that harmonize the least with the individual's face;
determining which one color palette of the two selected least harmonizing color palettes harmonizes best with the individual's face;
selecting the color palette that harmonizes the best with the individual's face from the two selected color palettes that harmonize the least with the individual's face;
correlating the selected least harmonizing color palette that harmonizes the best with the individual's face to a tertiary mind-body temperament, the tertiary mind-body temperament being different from the primary and secondary mind-body temperaments; and
correlating the least harmonizing color palette that harmonizes the least with the individual's face to a quaternary mind-body temperament, the quaternary mind-body temperament being different from the primary, secondary and tertiary mind-body temperaments.

22. A method of analyzing the personality of an individual, the method comprising:
determining which one of at least four shades of red harmonizes best with the individual's face;
selecting the shade of red that that harmonizes best with the individual's face;
identifying a mind-body temperament correlated to the selected red shade, the correlation of the mind-body temperament and the selected red shade having been predetermined;
determining which set of colored patterns selected from a group of at least four sets of colored patterns harmonizes best with the individual's face;
selecting the set of colored patterns that harmonizes best with the individual's face;
identifying the mind-body temperament correlated to the selected colored pattern, the correlation of the mind-body temperament and the selected colored pattern having been predetermined;
determining which metal palette selected from a group of at least four metal palettes harmonizes best with the individual's face, each metal palette comprising a plurality of sections, each section comprising a metallic color and being different from each other section;
selecting the metal palette that harmonizes best with the individual's face;
identifying the mind-body temperament correlated to the selected metal palette, the correlation of the mind-body temperament and the selected metal palette having been predetermined;
determining which red shape selected from a group consisting of at least two red shapes harmonizes best with the individual's face;
selecting the red shape that harmonizes best with the individual's face; and
identifying a mind-body temperament correlated to the selected red shape, the correlation of the mind-body temperament and the selected red shape having been predetermined;
determining which first color palette selected from a group of at least two color palettes harmonizes best with the individual's face, each color palette comprising a plurality of colored components, each colored component comprising a plurality of sections, each section comprising color and each section being different from each other section;
selecting the color palette that harmonizes best with the individual's face; and
identifying the mind-body temperament correlated to the first selected color palette, the correlation of the mind-body temperament and the first selected color palette having been predetermined, the identified mind-body temperament being the primary mind-body temperament of the individual.

23. The method of claim 22, wherein the group of at least two color palettes comprises at least four color palettes, the method further comprising:
determining which color palette from a group of three color palettes harmonizes the best with the individual's face, the group of three color palettes being the group of at least four color palettes minus the first color palette correlated to the primary mind-body temperament of the individual;
selecting a color palette that harmonizes best with the individual's face from the group of at least three color palettes, the selected color palette being the second selected color palette; and
identifying the mind-body temperament correlated to the selected second color palette, the correlation of the mind-body temperament and the second selected color palette having been predetermined, the identified mind-body temperament being the secondary mind-body temperament of the individual.

24. The method of claim 23 further comprising:
determining which two color palettes from the group of at least four color palettes harmonize least with the individual's face;
selecting a color palette that harmonizes the best with the individual's face from the two least harmonizing color palettes, the selected color palette being the third selected color palette; and
identifying the mind-body temperament correlated to the third selected color palette, the correlation of the mind-body temperament and the third selected color palette having been predetermined, the mind-body temperament correlated to the third selected color palette being the tertiary mind-body temperament of the individual.

25. The method of claim 24 further comprising:
selecting a color palette that harmonizes the least with the individual's face, the selected color palette being the fourth selected color palette; and
identifying the mind-body temperament correlated to the fourth selected color palette, the correlation of the mind-body temperament and the fourth selected color palette having been predetermined, the mind-body temperament correlated to the fourth selected color palette being the quaternary mind-body temperament of the individual.

26. The method of claim 22 further comprising:
assessing the relationship of the individual's face to at least four shapes, the four shapes comprising a circular shape, an oval shape, a triangular shape, and a rectangular shape;
determining which one of the at least four shapes harmonizes the best with the individual's face;
selecting the shape that harmonizes best with the individual's face; and
identifying the mind-body temperament correlated to the selected shape, the correlation of the mind-body temperament and the selected shape having been predetermined.

27. The method of claim 26, wherein assessing the relationship of the individual's face to the at least four shapes occurs prior to determining which one of at least four shades of red harmonizes best with the individual's face.

28. The method of claim 1 further comprising determining the perceived primary mind-body temperament of the individual, the determining comprising
determining to which mind-body temperament the first set of data exhibits the greatest degree of correlation and assigning the determined mind-body temperament as the first perceived personality style, and
determining to which mind-body temperament the second set of data exhibits the greatest degree of correlation and assigning the determined mind-body temperament as the second perceived personality style.

29. A method of analyzing the discontinuity in an individual's perceived personality style relative to the individual's assessed primary mind-body temperament, the method comprising:
comparing the perceived first and second personality styles of the method of claim 28 with the primary mind-body temperament of the method of claim 22;
determining whether there is a balance or an imbalance in the comparison; and
informing the individual of the balance or imbalance.
